(19) United States
(12) Patent Application Publication
(10) Pub. No.: US 2016/0025242 A1
(43) Pub. Date: Jan. 28, 2016

(54) FIXING DEVICE FOR FIXING AN ELEMENT

(71) Applicant: Airbus Operations GmbH, Hamburg (DE)

(72) Inventors: Hermann Benthien, Hamburg (DE); Andreas Poppe, Hamburg (DE)

(21) Appl. No.: 14/804,791

(22) Filed: Jul. 21, 2015

(30) Foreign Application Priority Data
Jul. 22, 2014 (DE) 10 2014 214 281.4

(51) Int. Cl. F16L 3/12; F16L 3/137; B64D 47/00; F16L 3/13

(52) U.S. Cl. CPC F16L 3/1222; F16L 3/1211; F16L 3/13; F16L 3/137; B64D 47/00

(57) ABSTRACT

A fixing device for fixing an element, in particular a line, a cable, a pipe, a hose or the like in an aircraft or spacecraft, to a component, includes an LFS fixing structure, the latching body and/or the flange portion of the LFS fixing structure having a tolerance compensator for compensating thickness tolerances of the entire arrangement.

### CROSS-REFERENCE TO RELATED APPLICATION

This application claims priority to DE 10 2014 214 281.4 filed Jul. 22, 2014, the entire disclosure of which is incorporated by reference herein.

### TECHNICAL FIELD

The present disclosure relates to a fixing device for fixing an element and also relates to an aircraft or spacecraft having a fixing device of this type.

### BACKGROUND

Although the present disclosure and the problem addressed thereby can be applied to any fixing devices, they will be described in detail with reference to the field of aviation and aerospace and in particular to an aircraft.

Modern aircraft or spacecraft have a large number of lines, for example cables for the transmission of current and data or signals, air conditioning ducts or lines, fresh water pipes and waste water pipes and the like. These lines are fixed for example to the primary structure by appropriate fixing devices.

The disclosure herein pertains to configuring fixings of this type as what are known as LFS fixings which have a holding portion for engaging around the line or cable to be received. Furthermore, these LFS fixings have a respective flange portion which serves as a support on an associated component and for this purpose comprises a corresponding through-hole. Inserted into this through-hole is a hollow latching body with spring portions which, based on a longitudinal axis of the latching body, comprise radially outer spring latching projections for latching positively to the component. Furthermore, securing pins can be inserted into the hollow latching body for securing the latching position thereof. In this respect, the axial length of the latching body and of the securing pin is to be adapted to the thickness measurements of the flange portion and of the component, on which the flange portion is to be fitted.

However in practice, the mentioned dimensions are subject to play or there are components or flange portions with differing thickness measurements. Furthermore, layers of paint or insulation layers can cause a certain play.

### SUMMARY

A fundamental idea of the present disclosure is that the fixing device for fixing an element, in particular a line, a cable, a pipe, a hose or the like in an aircraft or spacecraft, to a component comprises a holding portion to engage around at least portions of the element; a flange portion for resting on the component, the flange portion having a passage opening; and a latching body which is insertable into the passage opening and into an associated opening in the component and which has on the front end face, based on the longitudinal axis of the latching body radially outer spring latching projections which project through the opening in the component to latch the latching body to the component in a latching position; the latching body and/or the flange portion having at least one tolerance compensator for compensating thickness tolerances.

Thus, the present disclosure has an advantage that inaccuracies due to play in, for example, the thicknesses of the flange portion, of the holding portion and of the associated component or of possible coatings can be compensated to ensure a secure and stable fixing of the fixing device to the associated component. Consequently, it is advantageously possible within the region of specific tolerances to use LFS fixings with predetermined standard dimensions. In turn, the use of standardized LFS fixings of this type is advantageously associated with relatively low production costs and a relatively low assembly effort.

Advantageous embodiments and improvements of the fixing device are disclosed herein.

According to one embodiment, the flange portion has as a tolerance compensator, a first wedge portion and a second wedge portion, the inclined surfaces of which are oriented such that they rest on one another and are approximately parallel to one another, the first wedge portion and the second wedge portion being configured to be movable relative to one another along the inclined surfaces to vary the thickness of the flange portion. Due to this relative movement of the two adjacent wedge portions, the user can easily and economically adapt the thickness of the flange portion to the actual thickness of the associated component or to other inaccuracies such that standardized LFS fixings are used optimally and allow a secure and stable fixing of the flange portion to the associated component.

According to a further embodiment, the inclined surfaces of the two wedge portions have mutually corresponding tooth systems for a positive interlocking of the two wedge portions. The number of the individual locking teeth and the corresponding gradients of the tooth systems as well as the tooth width and height can be advantageously varied and correspondingly adapted to the tolerance ranges to be customarily compensated. For example, a plurality of standardized flange portions with differing tooth systems are provided for compensating differing tolerance ranges or for providing differing fine adjustments as a choice.

According to a further development, the first wedge portion has an approximately round through-hole and the second wedge portion has a continuous slotted hole such that, during a relative movement of the two wedge portions resting on one another along the inclined surfaces, these holes form an aligning region to form the passage opening to accommodate the latching body. This ensures in a simple and economical manner the possibility of using the LFS fixings in different relative positions of the two wedge portions.

According to a further development, the first wedge portion and/or the second wedge portion and/or the latching body and/or a securing pin are formed together in one piece, in particular via appropriate material bridging portions or wire connections. This means that the assembly effort is greatly simplified because the user only needs to select one correspondingly suitable fixing device for the respective case of use. Consequently, a necessary selection as for a modular principle is advantageously avoided.

According to a further embodiment, the flange portion and the latching body have as a tolerance compensator mutually corresponding tooth systems in the circumferential region of the passage opening such that the latching body can be braced against the component during a movement directed counter to the insertion direction relative to the flange portion according to the ratchet or cable tie principle. Consequently, specific tolerances can also be compensated in a simple and economical manner by lashing the latching body such that a fixed and stable fixing is ensured even when components or flange portions with play are present.

According to a further development, the tooth system of the latching body has a radial expanse which is approximately the same size as or greater than the radial expanse of the opening in the component. If the tooth system has a radial expanse which is greater than the radial expanse of the opening in the component, the tooth systems of the latching body can possibly be used as contact elements for facilitating the insertion procedure of the latching body into the associated opening in the component. If the radial expanse is approximately the same size as the radial expanse of the opening in the component, the same latching bodies can advantageously also be used for different component thicknesses, since the tooth system of the latching body can optionally also lie in the opening in the component.

According to a further development, the latching body has an adjusting structure for facilitating the relative movement. For example, this adjusting structure can be configured as a tension strap provided at a free end.

According to a further development, the flange portion has in the region of the passage opening associated with the opening in the component an opening widening for easier insertion of the tooth system of the latching body. This opening widening can advantageously be disc-shaped or conical.

According to a further embodiment, the latching body is configured as a tolerance compensator with a shoulder region which has at least one wedge portion which cooperates with a corresponding wedge portion of the flange portion, such that during an axial rotation of the latching body, the latching body is adjustable in the longitudinal direction relative to the flange portion. In this way, a tolerance compensation can also be ensured in a simple and economical manner, for example in the case of slightly varying component thicknesses, flange thicknesses or layer thicknesses.

The number of wedge portions of the shoulder region of the latching body and the number of wedge portions of the flange portion, the corresponding gradients of the wedge portions and the peripheral size of the surfaces comprising the wedge portions are preferably established subject to the desired amount of tolerance compensation and/or to the desired fine adjustment of the tolerance compensation. For example, standardized LFS fixings with fixing devices adapted to the component thickness and to tolerances which are to be expected can be advantageously provided. This simplifies the assembly process and reduces the assembly costs.

According to a further development, the shoulder region of the latching body has a tooth system which is preferably oriented in the radial direction and cooperates with a corresponding opposing tooth system of the flange portion for ensuring the position of the latching body, for example according to the ratchet or cable tie principle. This ensures in a simple and economical manner a positionally secured tolerance compensation.

According to a further development, the latching body is hollow and the fixing device has a securing pin which can be inserted into the hollow latching body to secure the latching position.

According to a further development, the latching body has a receiving region for receiving an associated rotating tool. Here, known seats such as hexagon, slotted or crossed seats can be provided in the latching body for the rotation thereof.

According to a further embodiment, a flexible disc or the like, in particular a rubber disc, is provided between the flange portion and the component in the region of the passage opening. This flexible disc can preferably also have an increased static friction coefficient so that apart from additional tolerance compensation, additional rotation prevention is also ensured.

### BRIEF DESCRIPTION OF THE DRAWINGS

In the following, the disclosure herein will be described in more detail on the basis of embodiments with reference to the accompanying drawings, in which:

FIG. 1 is a schematic cross-sectional view of a fixing device according to a first embodiment of the present disclosure;

FIG. 2 is a schematic cross-sectional view of a fixing device according to a second embodiment of the present disclosure;

FIG. 3 is a schematic cross-sectional view of a latching body inserted into a component according to a third embodiment of the present disclosure;

FIG. 4 is a schematic cross-sectional view of the inserted latching body from FIG. 3 with inserted securing pin according to the third embodiment of the present disclosure;

FIG. 5 is a schematic cross-sectional view of a fixing device according to the third embodiment of the present disclosure;

FIG. 6 is a schematic cross-sectional view of a fixing device according to a fourth embodiment of the present disclosure;

FIG. 7 is a schematic cross-sectional view of a fixing device according to a fifth embodiment of the present disclosure;

FIG. 8 is a schematic view, projected into the plane of the drawing, of the wedge surface profiles of a fixing device according to the fifth embodiment of the present disclosure in a position without tolerance compensation; and

FIG. 9 is a schematic view, projected into the plane of the drawing, of the wedge surface profiles of a fixing device according to the fifth embodiment of the present disclosure in a position with tolerance compensation.

### DETAILED DESCRIPTION

In the drawings, the same reference signs denote the same or functionally identical components, unless indicated otherwise. It is pointed out here that in all the figures, the corresponding parts are not shown true-to-scale, but merely schematically.

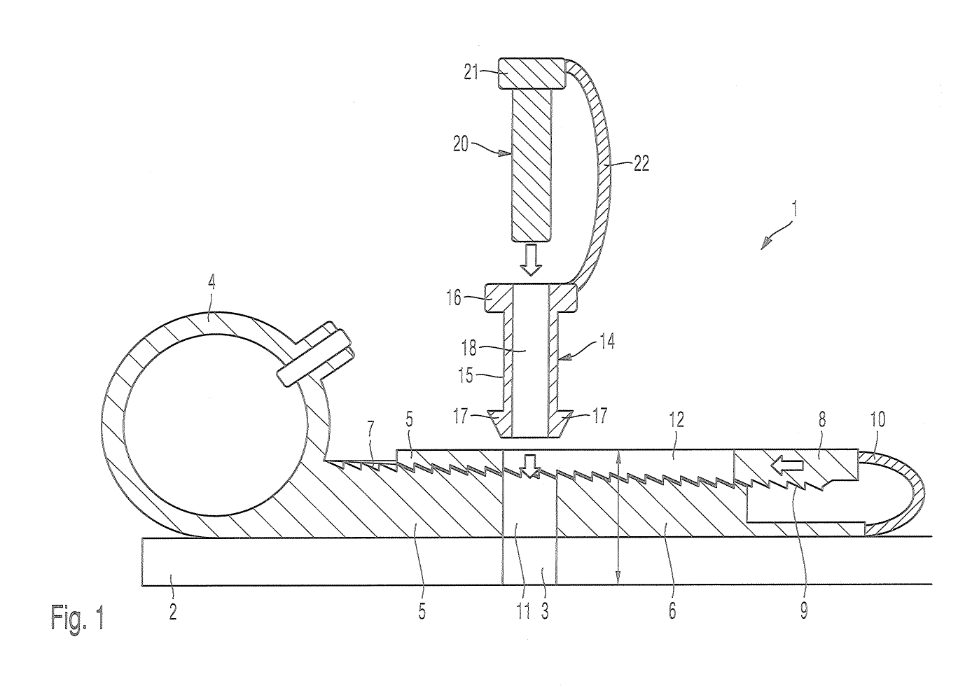

In the following, a fixing device according to a first preferred embodiment of the present disclosure is described in detail with reference to FIG. 1. FIG. 1 is a schematic cross-sectional view of a fixing device 1 which is to be fixedly mounted on a component 2. For its part, the component 2 can be fixed for example to a structure, in particular of an aircraft or spacecraft, so that the component 2 acts as a type of adapter. Component 2 is used as an adapter, for example in the aerospace industry, if an element is to be attached to a primary structure of an aircraft and if open holes in the primary structure are not permitted. In the absence of such regulations, the fixing device 1 can also be directly attached to the structure so that in this case the component 2 is the actual primary structure.

The fixing device 1 has a holding portion 4 to receive an element which is not shown in the figures for the sake of clarity, in particular a line such as a cable and/or bunched cables. The holding portion 4 can be configured for example as a round clamp or the like.

Furthermore, the fixing device 1 has a flange portion 5. According to the first embodiment shown in FIG. 1, the flange portion 5 has as a tolerance compensator a first lower wedge portion 6. The first wedge portion 6 has a first tooth system 7 extending along a first inclined surface. Furthermore, the flange portion 5 comprises a second upper wedge portion 8 with a second tooth system 9 along a second inclined surface. In the case of use, the inclined surfaces of the two wedge portions 6, 8 are configured resting on one another to form the entire flange portion 5. The gradients of the first and second wedge portions 6, 8 and the configuration of the first and second tooth systems 7, 9 correspond to one another such that, as shown in FIG. 1, a flush meshing of the tooth systems 7, 9 of the two wedge portions 6, 8 is preferably ensured.

For example, the first wedge portion 6 and the second wedge portion 8 are coupled together by a connector 10 so that the holding portion 4 is formed as a one-piece component together with the two wedge portions 6, 8. The connector 10 can be configured for example as a material bridge or a wire connection 10 or the like.

The first wedge portion 6 has a round through-hole 11 and the second wedge portion 8 has a continuous slotted hole 12. The two holes 11, 12 are aligned with one another such that during a relative movement of the two wedge portions 6, 8 along the inclined surfaces, an aligning region is formed which defines a common passage opening into which a latching body 14, described further below, can be inserted.

The two inclined surfaces having the first tooth system 7 and the second tooth system 9 of the two wedge portions 6, 8 are preferably configured approximately parallel to one another, the corresponding tooth systems 7, 9 ensuring a relative movement of the two wedge portions 6, 8 in a preferred adjustment direction according to the ratchet or cable tie principle by a corresponding configuration of the tooth systems 7, 9. In FIG. 1, this adjustment direction is illustrated by way of example by the horizontal arrow.

As is also shown in FIG. 1, the fixing device 1 also has a latching body 14 which, according to the first embodiment shown in FIG. 1, is tubular and has a cylindrical shank 15 with a predetermined inner contour which has in particular a constant internal diameter. The outer contour of the shank 15 preferably also has a constant external diameter and approximately corresponds to an inner contour of the round through-hole 11 in the first wedge portion 6. The shank 15 extends between an annular shoulder region 16 and a plurality of spring latching projections 17 on the foot side. Furthermore, the latching body 14 has a through-hole 18 into which an associated securing pin 20 can be inserted. The securing pin 20 also has an approximately annular shoulder region 21.

As is also shown in FIG. 1, according to the first preferred embodiment, the latching body 14 is formed in one piece with the securing pin 20, for example again via a wire connection 22, a material bridge or the like.

In the following, the mounting of the fixing device 1 on the component 2 will be described in detail with reference to FIG. 1. By way of example, the state of the flange portion 5 shown in FIG. 1 is the starting position. In this starting position, the flange portion 5 is arranged together with the holding portion 4 on the associated component 2 such that the round through-hole 11 in the first wedge portion 6 approximately aligns with an opening 3 in the component. In this starting position, the second wedge portion 8 is located on the first wedge portion 6 such that the end of the slotted hole 12, facing the holding portion 4, in the second wedge portion 8 approximately corresponds to the end of the round through-hole 11, facing the holding portion 4, in the first wedge portion 6. In the embodiment shown in FIG. 1, the two inclined surfaces are respectively inclined in the direction of the component 2 away from the holding portion 4.

In this starting position shown in FIG. 1, the latching body 14 is then inserted through the slotted hole 12 in the second wedge portion 8, through the through-hole 11 in the first wedge portion 6 and through the opening 3 in the component 2, the spring latching projections 17 engaging behind the component 2 on the underside around the opening 3. Due to possible dimensions with play, for example of the first and second wedge portions 6, 8, of the component 2, of a possible paintwork of the component 2 or of insulation layers which may have been provided, the length of the shank 15 of the latching body 14 can be greater than the sum of the lengths of the opening 3, the through-hole 11 and of the slotted hole 12, etc. In this case, the tolerance compensator according to the disclosure herein is used to compensate the above-mentioned tolerances. For this tolerance compensation, according to the first preferred embodiment, the second wedge portion 8 is moved or pushed relative to the first wedge portion 6 towards the holding portion 4 in the direction of the horizontal arrow shown in FIG. 1.

The tooth systems 7, 9 are preferably configured corresponding to one another such that a relative movement of the two wedge portions 6, 8 in the above-mentioned direction causes a ratchet effect or a cable tie effect. Consequently, the two wedge portions 6, 8 latch in a preferred position relative to one another by the tooth systems 7, 9. The tooth systems 7, 9 preferably form a positive mutual latching of the two wedge portions 6, 8.

In the case of use, the second wedge portion 8 is preferably moved relative to the first wedge portion 6 in the direction shown by the horizontal arrow in FIG. 1 until the first wedge portion 6 and the holding portion 4 are firmly braced with the component 2, because then any possible tolerances due to the increased overall height of the two wedge portions 6, 8 are compensated by the relative movement.

Finally, in the firmly braced position, the securing pin 20 is introduced into the through-hole 18 in the latching body 14 until the shoulder region 21 of the securing pin 20 is preferably in contact with the shoulder region 16 of the latching body 14.

Materials for the fixing device 1, in particular for the holding portion 4, the flange portion 5 consisting of the first wedge portion 6 and of the second wedge portion 8, the latching body 14 and the securing pin 20 can be produced from an injection moulded material, for example polyamide PA66 or the like. It is obvious to a person skilled in the art that other suitable materials can also be used. Depending on the case of use, the wedge shapes and orientations of the inclined surfaces can also differ from the forms shown in the figures in a purely exemplary and merely schematic manner, and they can be varied accordingly.

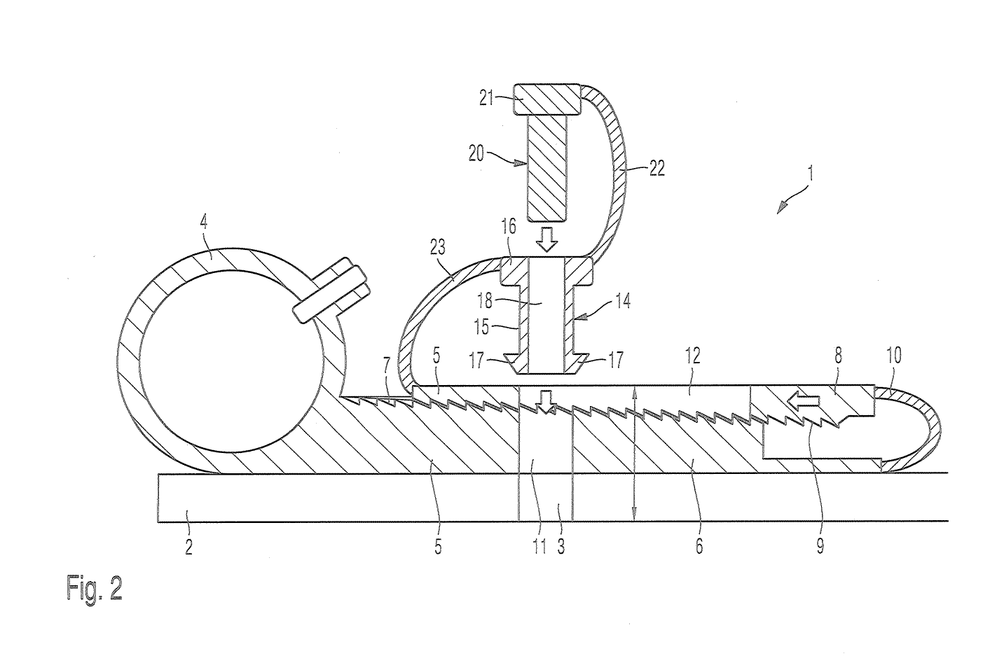

In the following, a second preferred embodiment of the present disclosure will be described in detail with reference to FIG. 2, this figure being a schematic cross-sectional view of the fixing device 1.

The second preferred embodiment substantially corresponds to the first embodiment according to FIG. 1 described above, and according to the second preferred embodiment shown in FIG. 2, the entire fixing device 1 is configured as a single-piece component. In contrast to the above-mentioned first embodiment, the latching body 14 is connected to the second wedge portion 8 also by a material bridge or a connecting wire 23 or the like. The length and dimensions of this material bridge or of this connecting wire 23 are to be selected appropriately such that the securing pin 20 can be easily inserted into the mutually aligning openings or holes 3, 11 and 12 even during a maximum movement of the two wedge portions 6, 8 relative to one another. The length of the material bridge 23 or of the connecting wire 23 is to be understood merely schematically in FIG. 2.

Furthermore, a person skilled in the art can appreciate that to reduce the number of components, any components of the fixing device 1 can be formed in one piece with corresponding other components via material bridges or connections of this type. For example, the securing pin 20 can also be formed in one piece with the latching body 14 and simultaneously with one of the two wedge portions 6, 8 via a connector of this type. Any combinations are possible here. The connection points of the connector are also not restricted to the connection points shown in FIGS. 1 and 2, but can be varied accordingly.

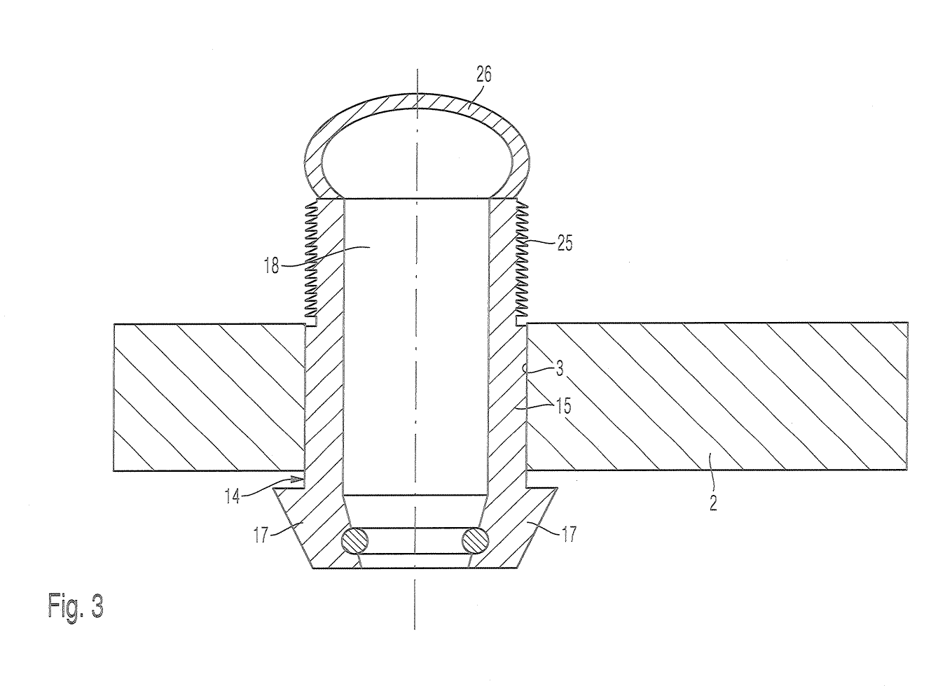

In the following, a fixing device 1 according to a third preferred embodiment of the present disclosure is described in detail with reference to FIGS. 3 to 5. FIG. 3 is a schematic cross-sectional view of a component 2 which has an opening 3 for receiving an associated latching body 14.

The latching body 14 inserted into the opening 3 has a shank 15 and the spring latching projections 17 which have already been described above. According to the present embodiment, the shank 15 consists of two portions, the shank portion 15 inserted into the opening 3 being hollow cylindrical. The second shank portion has a tooth system 25 formed in the radial direction and, following insertion of the latching body 14, the second shank portion preferably protrudes out of the opening 3 in the component 2.

Furthermore, the latching body 14 has an adjustment or adjustment structure, for example a tension strap 26, which is provided next to the tooth system 25 on the free frontal end of the latching body 14, as shown in FIG. 3.

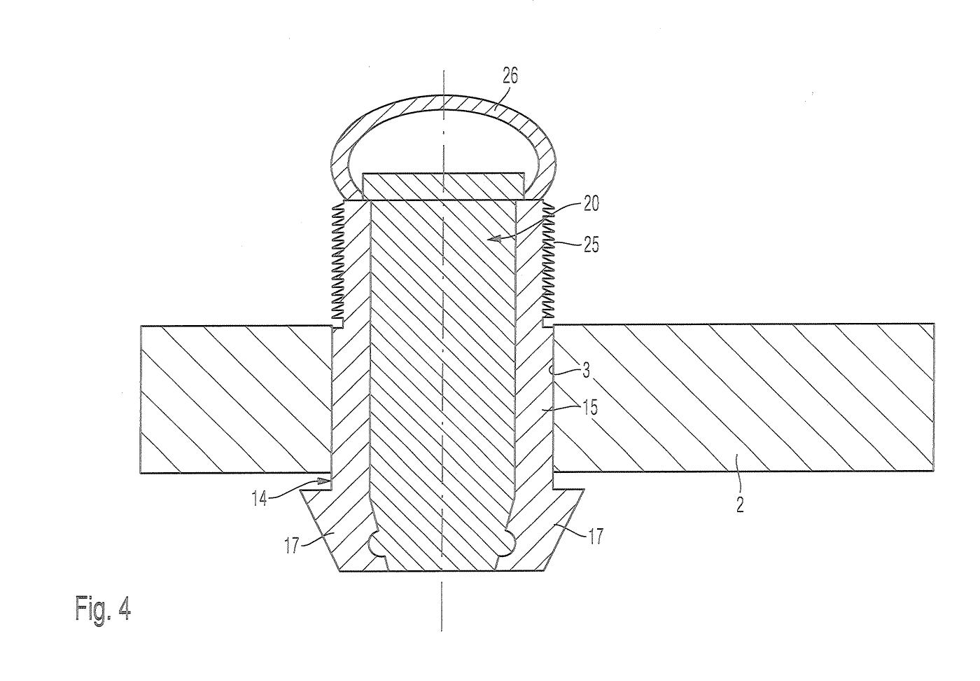

After the latching body 14 has been introduced into the opening 3 in the component 2, a securing pin 20 is inserted into the through-hole 18 in the latching body 14 to secure the position of the latching body 14, as shown in FIG. 4.

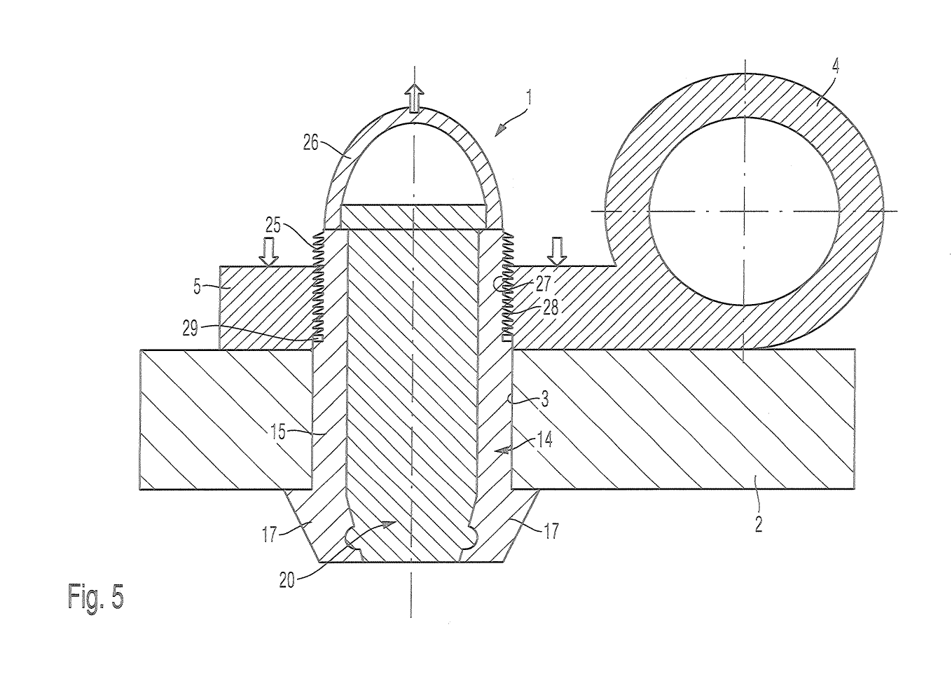

Furthermore, according to the third embodiment, the fixing device 1 again has a holding portion 4 and a flange portion 5 which are preferably formed in one piece with one another, as shown schematically in FIG. 5. The flange portion 5 comprises a passage opening 27 which has a tooth system 28 corresponding to the tooth system 25 of the latching body. The tooth systems 25, 28 are configured to correspond to one another such that a relative movement takes place between the latching body 14 and the flange portion 5 according to the ratchet principle or cable tie principle and the latching body 14 and the flange portion 5 can be latched together in the desired adjustment position. As shown in FIG. 5, after the flange portion 5 has been positioned on the latching body 14, the latching body 14 is moved upwards relative to the flange portion 5 by the tension strap 26 and the flange portion 5 is moved in the direction of the two downwardly directed arrows which are shown. Due to the previously described ratchet principle or cable tie principle by the tooth systems 25, 28 and by the spring latching projections 27 engaging behind the component 2, the fixing device 1 can consequently be firmly braced on the component 2 with the compensation of any tolerances which arise.

As shown in FIG. 5, in this embodiment the radial expanse of the tooth system 28 of the latching body 14 approximately corresponds to the diameter of the opening 3 in the component 2. As a result, the same fixing devices 1 can advantageously also be used for an attachment to components 2 of different thicknesses, since for a thicker component 2 than shown in FIG. 5, the tooth system 28 can optionally be received in the opening 3 in the component 2.

The flange portion 5 preferably has in the end region of the passage opening 27 facing the component 2 an opening widening 29 which can be for example annular or peripherally conical. An opening widening 29 of this type advantageously serves to facilitate the introduction of the latching body 14 into the passage opening 27 in the flange portion 5 and also serves to use the fixing device 1 for different components 2, since in the case of thinner components 2, a shank portion 15 projecting above out of the component 2 can be received in the opening widening 29. This seat promotes a centring of the flange portion 5 on the component 2 when the fixing device 1 is braced on the component 2.

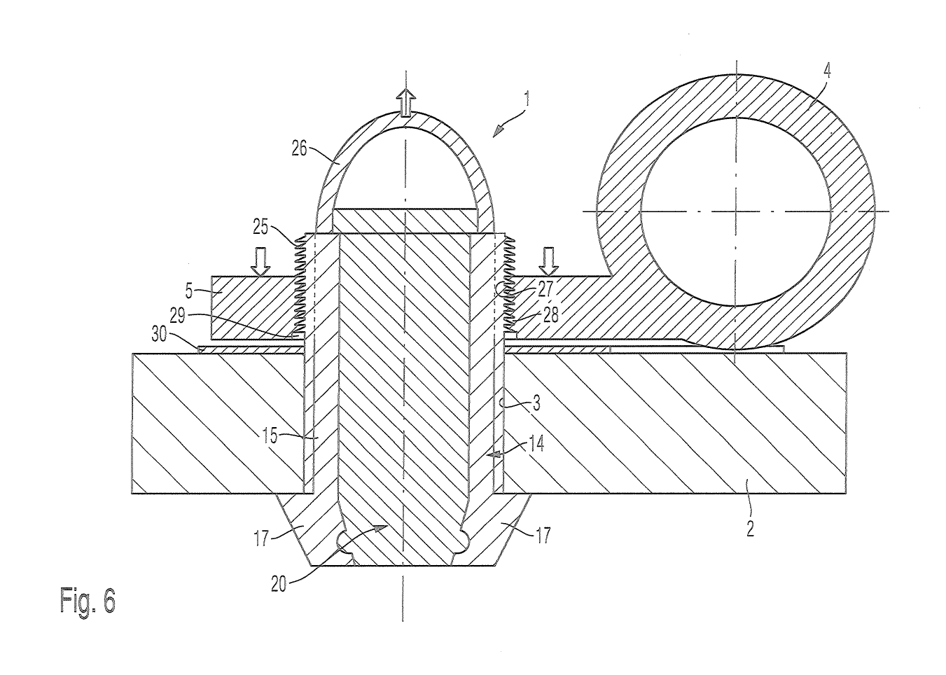

In the following, a fixing device 1 according to a fourth preferred embodiment of the present disclosure is described in detail with reference to FIG. 6. In respect of features which are not described in detail, reference is made to the description of the third preferred embodiment.

In contrast to the third embodiment, the tooth system 28 of the latching body 14 has a radial expanse which is greater than the diameter of the opening 3 in the component 2. In this case, the tooth system 28 can serve as a stop element for restricting the insertion depth into the opening 3 and for holding the latching body 14 in the opening 3 in the component 2. The opening widening 29 has been adapted to the tooth system 28 according to the widened dimensions of the tooth system 28, as shown in FIG. 6.

Furthermore, according to the present embodiment, a flexible element 30, for example a flexible rubber disc or the like, is provided as an additional tolerance compensator between the flange portion 5 and the component 2. Due to this flexible element 30, when the fixing device 1 is braced on the component 2, an additional tolerance compensation can be ensured and due to an increased friction coefficient of the flexible element 30, the flange portion 5 can be additionally prevented from rotating with respect to the component 2.

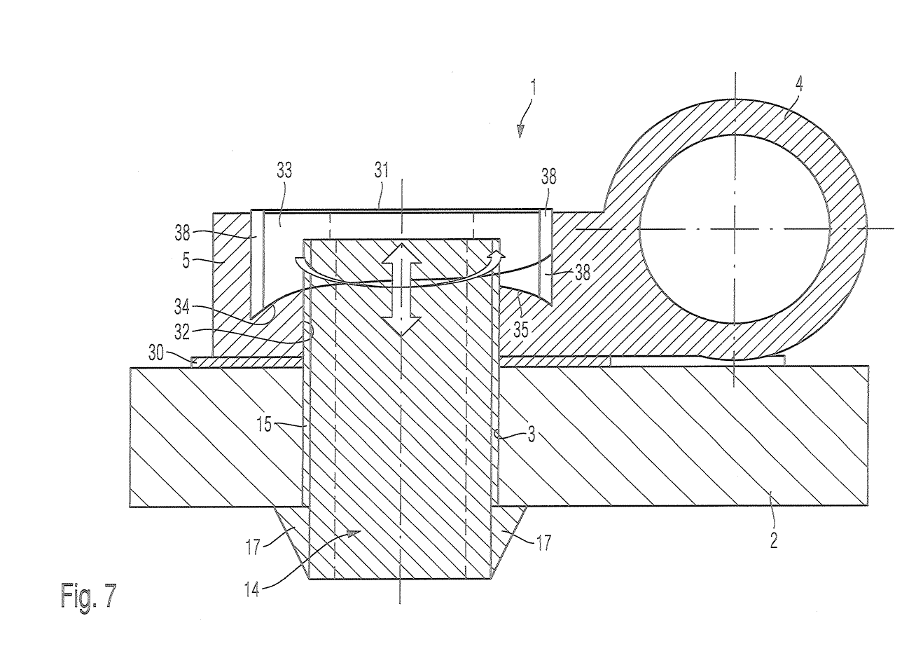

In the following, a fixing device according to a fifth preferred embodiment of the present disclosure is described in detail with reference to FIGS. 7 to 9. According to the fifth embodiment, the fixing device 1 has a latching body 14 which in respect of the shank 15 and the spring latching projections 17 is configured analogously to the latching body 14 of the first and second embodiments. With regard to these features and features which are not described in detail in the following, reference is made to the description provided above.

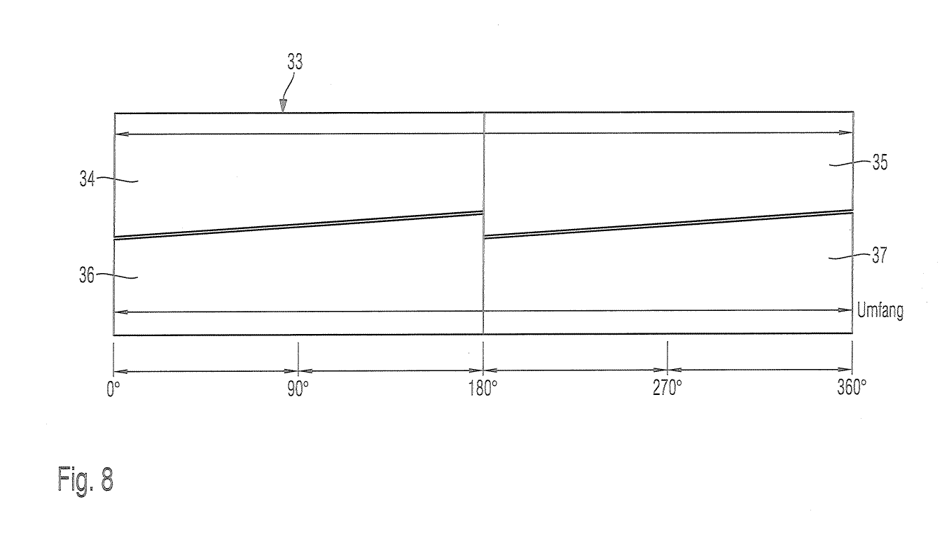

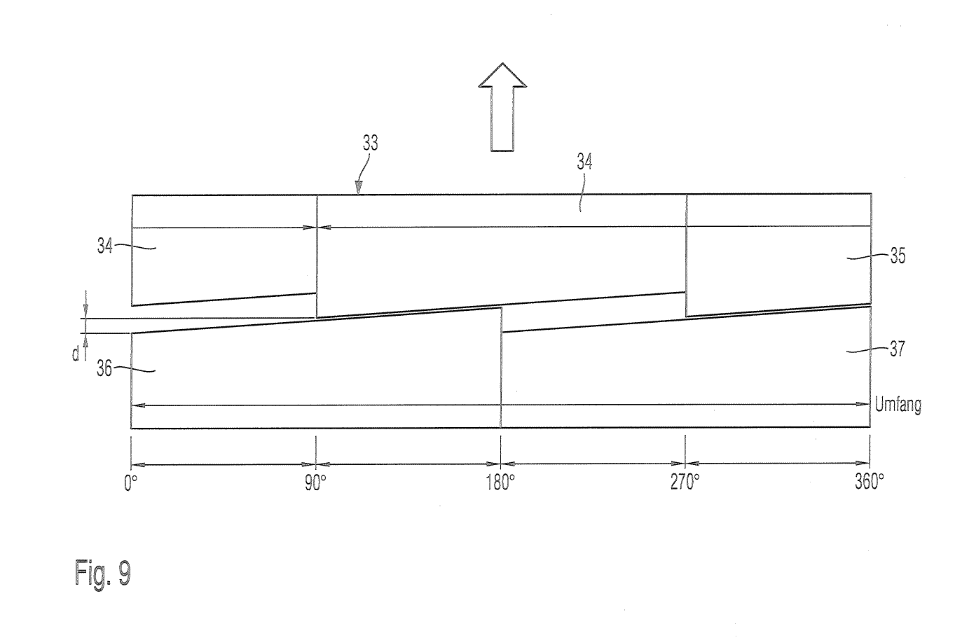

The latching body 14 according to the fifth embodiment has as a tolerance compensator a shoulder region 33 on the head side which comprises a first wedge portion 34 and a second wedge portion 35. The flange portion 5 accordingly has corresponding wedge portions 36, 37. The wedge portions 34, 35 and 36, 37 in FIGS. 8 and 9 have been shown projected into the plane of the drawing to simplify the illustration of the mode of operation of a tolerance compensation according to the fifth embodiment of the present disclosure.

FIG. 8 shows the starting position of the latching body 14 which has been inserted into the passage opening 33 in the flange portion 5 and in which the first wedge portion 34 of the shoulder region 33 of the latching body 14 positively cooperates with the first corresponding wedge portion 36 of the flange portion 5 and in which the second wedge portion 35 of the shoulder region 33 of the latching body 14 positively cooperates with the second corresponding wedge portion 37 of the flange portion 5.

Proceeding from this starting position, during an axial rotation of the latching body 14 and thereby of the shoulder region 33, a height offset d can be ensured to compensate tolerances, as schematically shown in FIG. 9. FIG. 9 shows the state in which the shoulder region 33 of the latching body 14 has been rotated by 90° from the starting position shown in FIG. 8. Upon a further rotation, a greater height offset can be produced, the maximum of which for respectively two provided wedge portions is 180°.

As also shown in FIG. 7, the shoulder region 33 preferably has a radial tooth system 38 which cooperates with a corresponding opposing tooth system of the flange portion 5 such that the latching body 14 can be latched in a stable manner in its axially rotated position. Here again, this can take place for example according to the ratchet principle or the cable tie principle, while other latching structures are also possible.

The embodiment shown in FIGS. 7 to 9 has two wedge portions 34, 35 of the latching body 14 and accordingly two corresponding wedge portions 36, 37 of the flange portion 5. However, it is obvious to a person skilled in the art that only one wedge surface or more than two wedge surfaces of the latching body 14 with a corresponding number of corresponding wedge surfaces of the flange portion 5 can be provided. The number of wedge portions of the shoulder region 33 of the latching body 14 and the wedge portions of the flange portion 5, the corresponding gradients of the wedge portions and the peripheral size of the surfaces comprising the wedge portions can be varied according to the respective requirements. If for example a more finely graduated tolerance compensation is required, the gradients of the wedge portions can be reduced and/or the number of wedge portions can be increased accordingly. In turn, a greater number of wedge portions can entail a greater peripheral size of the surfaces comprising the wedge portions. The maximally adjustable height offset can also be fixed by the corresponding number of wedge portions and by the corresponding gradients.

Furthermore, analogously to the fourth embodiment of the present disclosure, here again a flexible element 30, for example in the form of a rubber disc or the like, can be provided between the flange portion 5 and the component 2 in particular around the passage opening 32 or around the opening 3 as an additional tolerance compensator and/or as an additional anti-rotator of the flange portion 5 relative to the component 2, as shown in FIG. 7.

Furthermore, on the end face of the shoulder region 33, the latching body 14 can preferably have a receiving region 31 into which an associated rotating tool for axially rotating the latching body 14 can be inserted. For example, the receiving region 31 can be configured as a hexagonal seat, a slotted seat or as a cross-recessed seat or the like.

Although the present disclosure has been described above on the basis of preferred embodiments, it is not restricted thereto, but can be modified in many different ways.

In particular, the embodiments described above can also be combined with one another, so that a fixing device can have diverse tolerance compensators.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fixing device for fixing an element to a component, comprising:
a holding portion for engaging around at least portions of the element;
a flange portion for resting on the component, wherein the flange portion has a passage opening; and
a latching body insertable into the passage opening and into an associated opening in the component and having on the front end face based on the longitudinal axis of the latching body radially outer spring latching projections which project through the opening in the component, for latching the latching body to the component in a latching position;
wherein the latching body and/or the flange portion has a tolerance compensator for compensating thickness tolerances.

2. The fixing device according to claim 1, wherein the flange portion has as a tolerance compensator a first wedge portion and a second wedge portion, the inclined surfaces of which rest on one another and are oriented approximately parallel to one another, the first wedge portion and the second wedge portion being configured such that they are movable relative to one another along the inclined surfaces to vary the thickness of the flange portion.

3. The fixing device according to claim 2, wherein the inclined surfaces of the two wedge portions have mutually corresponding tooth systems for a positive latching together of the two wedge portions.

4. The fixing device according to claim 2, wherein the first wedge portion has an approximately round through-hole and the second wedge portion has a continuous slotted hole such that during a relative movement of the two wedge portions along the inclined surface, these holes form an aligning region to form the passage opening in the flange portion to accommodate the latching body.

5. The fixing device according to claim 2, wherein the first wedge portion and/or the second wedge portion and/or the latching body and/or a securing pin are formed together in one piece by a connector.

6. The fixing device according to claim 1, wherein the flange portion and the latching body have as a tolerance compensator mutually corresponding tooth systems at least in the circumferential region of the passage opening in the flange portion such that the latching body can be braced against the component during a movement, directed against the insertion direction, relative to the flange portion.

7. The fixing device according to claim 6, wherein the tooth system of the latching body has a radial expanse which is approximately the same size as or is greater than the radial expanse of the opening in the component.

8. The fixing device according to claim 6, wherein the latching body has an adjustment structure that can be used to facilitate the relative movement.

9. The fixing device according to claim 6, wherein the flange portion has an opening widening in the region of the passage opening associated with the opening in the component.

10. The fixing device according to claim 1, wherein the latching body as a tolerance compensator is configured with a shoulder region which has at least one wedge portion which cooperates with a corresponding wedge portion of the flange portion such that when the latching body rotates axially, the latching body being adjustable in a longitudinal direction relative to the flange portion.

11. The fixing device according to claim 10, wherein the number of wedge portions of the shoulder region, of the latching body and of the flange portion, the corresponding gradients of the wedge portions and the peripheral size of the surfaces comprising the wedge portions are established subject to the required tolerance compensation amount and/or to the required fine adjustment of the tolerance compensation.

12. The fixing device according to claim 10, wherein the shoulder region of the latching body has a tooth system which is oriented in the radial direction and cooperates with a corresponding opposing tooth system of the flange portion for securing the position of the latching body.

13. The fixing device according to claim 1, wherein the latching body is hollow and the fixing device has a securing pin insertable into the hollow latching body to secure the latching position.

14. The fixing device according to claim 10, wherein a flexible element is provided between the flange portion and the component at least around the region of the passage opening.

15. An aircraft or spacecraft with at least one fixing device, the fixing device comprising:
a holding portion for engaging around at least portions of the element;
a flange portion for resting on the component, wherein the flange portion has a passage opening; and
a latching body insertable into the passage opening and into an associated opening in the component and having on the front end face based on the longitudinal axis of the latching body, radially outer spring latching projections which project through the opening in the component, for latching the latching body to the component in a latching position;
wherein the latching body and/or the flange portion has a tolerance compensator for compensating thickness tolerances.

16. The fixing device according to claim 1, wherein the fixing device is used to fix a line, a cable, a pipe, a hose or the like in an aircraft or spacecraft.

17. The fixing device according to claim 5, wherein the connector comprises material bridges or wire connections.

18. The fixing device according to claim 6, wherein the latching body can be braced against the component during a movement, directed against the insertion direction, relative to the flange portion according to the ratchet or cable tie principle.

19. The fixing device according to claim 8, wherein the adjustment structure comprises a tension strap.

20. The fixing device according to claim 14, wherein the flexible element comprises a rubber disc.
